(19) United States
(12) Patent Application Publication
(10) Pub. No.: US 2009/0133046 A1
(43) Pub. Date: May 21, 2009

(54) Disc Guiding Apparatus having a Logic Apparatus

(75) Inventor: Tai-Kuo Wang, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: LITE-ON IT CORPORATION, Taipei City (TW)

(21) Appl. No.: 11/943,109

(22) Filed: Nov. 20, 2007

(51) Int. Cl. G11B 17/04

(52) U.S. Cl. 720/645

(57) ABSTRACT

The present invention discloses a disc guiding apparatus including a logic apparatus and a first and a second disc guiding elements. The logic apparatus has a rod, a first and a second guiding elements, and a first and a second moving parts. The first and the second disc guiding elements are connected to the first moving part and the second moving part, respectively. The first and the second moving parts move along the extended direction of the rod by the first and the second guiding elements. The rod has a central portion and two ends, wherein the width of the central portion is narrower than each of the two ends. The first and the second moving parts are disposed at the different ends of the rod.

### FIELD OF THE INVENTION

The present invention relates to a disc guiding apparatus, and more particularly to a disc guiding apparatus having a logic apparatus for an optical disk drive.

### BACKGROUND OF THE INVENTION

The optical disc drives are widely used nowadays because the storage mediums for the disc drives are cheap and have the advantage for easy portable. The optical disk drive reads data stored on the storage medium and writes data onto the storage medium. The optical disc drives are classified into computer products and consumer products according to their applications. The computer products are used for desktop computers or notebooks and the consumer products are used for home entertainment or car electronics such as the CD/VCD/DVD player and DVD recordable player.

The optical disc drives are further classified into two types, one is the tray-in type and the other is the slot-in type according to the ways for loading the discs. The tray-in type optical disk drive utilizes a tray, which extends from and retracts back to the optical disc drive. User places a disc on the tray or removes the disc from the tray when the tray is in extended position. The tray holding the disc thereon is received in the optical disc drive after the tray retracts back. The tray is able to hold different sized discs such as the 12 cm diameter disc or 8 cm diameter disc. On the other hand, the slot-in type optical disc drive has a disc loading/ejecting apparatus for automatically loading/ejecting the disc. User inserts the disc through an insertion slot such that the disc loading/ejecting apparatus can load the disc into the optical disc drive. When ejecting the disc, the disc is ejected partially at the insertion slot by the disc loading/ejecting apparatus so as to allow the user to remove the disc.

Traditionally, the slot-in type optical disc drive has other apparatuses so as to load different sized discs. The apparatuses include, for example, an electrical detecting instrument and a disc guiding apparatus both installed at the insertion slot. The electrical detecting instrument detects the size of the inserted disc and sends a signal to the disc loading/ejecting apparatus. The disc guiding apparatus guides the disc to an appropriate position which is suitable for the disc loading/ejecting apparatus to load the disc. And then, the disc loading/ejecting apparatus is modified according to the signal generated by the detecting instrument to provide a proper way to load the disc.

However, the development of the optical disc drives is toward slim and small. There is no spare space for installing both the disc guiding apparatus and the electrical detecting instrument in a small optical disc drive. Moreover, the more apparatus installed in the optical disc drive will increase the cost of the optical disc drive.

Therefore, the present invention is to provide a disc guiding apparatus having a logic apparatus to overcome the drawbacks of the slot-in type optical disc drive mentioned above.

### SUMMARY OF THE INVENTION

An object of the invention is to provide a logic apparatus. The logic apparatus has multiple states according to the operating process of the logic apparatus.

The other object of the invention is to provide a disc guiding apparatus having the logic apparatus. The disc guiding apparatus judges the different sized discs and sends signal to a disc loading/ejecting apparatus. The disc is guided to an appropriate position of the optical disc drive by the disc guiding apparatus and then the disc loading/ejecting apparatus is modified to load the disc according to the signal sent by the disc guiding apparatus.

The disc guiding apparatus of the present invention includes a logic apparatus and a first and a second disc guiding elements. The logic apparatus further includes a first and a second moving parts, a first and a second guiding elements and a rod. The rod is rotatable about a rotating point and has a central portion and two ends. The width of the central portion is narrower than the width of each of the two ends. The first and the second moving parts are disposed at the two sides of the rod, respectively. The first and the second guiding elements guide the two moving parts to move in the extended direction of the rod. The first and the second disc guiding elements are disposed at the insertion slot and connected to the first and the second moving parts, respectively.

Initially, the first moving part is disposed at the first end of the rod and the second moving part is disposed at the second end. When only one moving part is moved, the moved moving part is stopped at the central portion. Only when two moving parts are moved simultaneously or in turn, the two moving parts are able to move to the other end of the rod. Therefore, the movement of the disc guiding elements depends on the movement of the moving parts. And the disc guiding elements guide the inserted disc to an appropriate position to be loaded. Therefore the disc guiding apparatus can guide and judge different sized discs to be inserted into the optical disc drive without additional apparatus.

### BRIEF DESCRIPTION OF THE DRAWINGS

Other features and advantages of this invention will become more apparent in the following detailed description of the preferred embodiments of this invention, with reference to the accompanying drawings, in which:

FIG. 1 shows the sectional view of the first embodiment of a logic apparatus of the present invention.

FIG. 2 shows the sectional view of the second embodiment of the logic apparatus of the present invention.

FIG. 3 shows the first state of the logic apparatus of the present invention.

FIG. 4 shows the two moving parts are moved during operating process.

FIG. 5 shows the second state of the logic apparatus of the present invention.

FIG. 6 shows the perspective and sectional view of a disc drive having a disc guiding apparatus of the present invention.

FIG. 7 shows a small disc loaded into the optical disc drive at an appropriate position.

FIG. 8 shows the small disc loaded into the optical disc drive at an inappropriate position.

FIG. 9 shows the disc guiding apparatus guiding the disc at the inappropriate position to the appropriate position shown in FIG. 8.

FIG. 10 shows the large disc loaded into the optical disc drive.

FIG. 11 shows the disc guiding apparatus guiding the large disc to be loaded into the optical disc drive.

### DETAILED DESCRIPTIONS OF THE PREFERRED EMBODIMENT

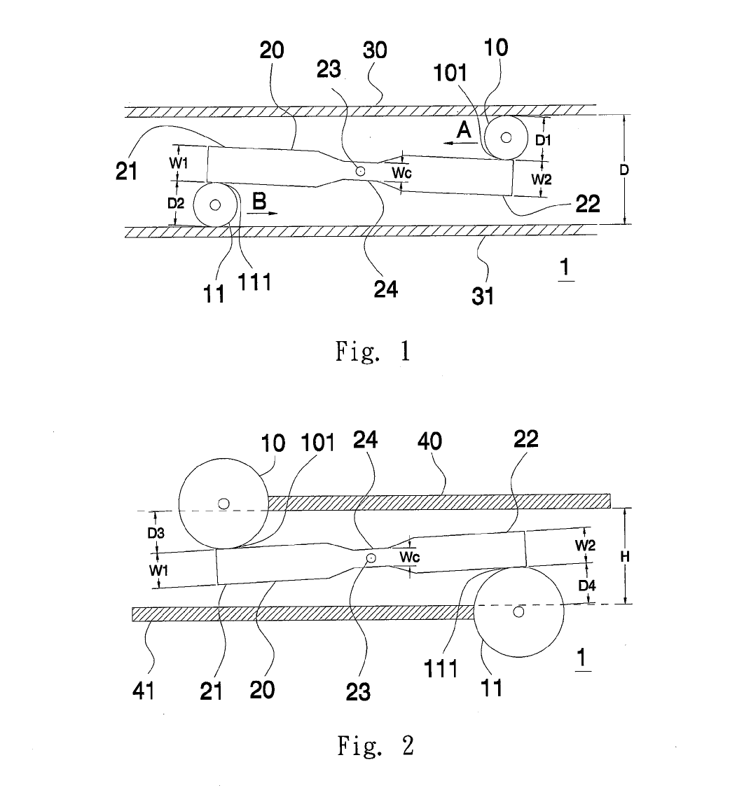

Referring to FIG. 1, a first preferred embodiment of a logic apparatus according to the present invention is shown. The logic apparatus 1 of the present invention includes a rod 20, a first and a second moving parts 10, 11, and a first and a second guiding elements 30, 31. In the first embodiment, the first and the second guiding elements 30, 31 are the first and the second boundaries 30, 31. The rod 20 is disposed between the first and the second boundaries 30, 31. The first and the second moving parts 10, 11 are disposed between the first boundary 30 and the rod 20 and between the second boundary 31 and the rod 20, respectively. The two moving parts 10, 11 move along the extended direction of the rod 20 because of the first and the second boundaries 30, 31. The first and the second moving parts 10, 11 move in the direction of arrows A and B as shown in FIG. 1.

The rod 20 is an axial-symmetric rod and has a central portion 24, a rotating point 23, and a first and a second ends 21, 22. The rod 20 is rotatable about the rotating point 23 set at the central portion 24. The width We of the central portion 24 is narrower than the width W1 of the first end 21 and the width W2 of the second end 22. The first and the second moving parts 10, 11 contact the rod 20 at the contacting points 101 and 111, respectively. The distance D1 is set between the contacting point 101 and the first boundary 30 and the distance D2 is set between the contacting point 111 and the second boundary 31. The distance between the first and the second boundaries 30, 31 is D. Then the relationships among D, D1, D2, Wc, W1 and W2 are listed as the following equations: D<D1+W1+D2, D<D1+W2+D2 and D>D1+Wc+D2.

Please refer to FIG. 2. A second preferred embodiment of the logic apparatus 1 is shown. The difference between the first and the second embodiments is that the two guiding members are the first and the second guiding grooves 40, 41. The other elements the notations are the same as the first embodiment. In FIG. 2, the two moving parts 10, 11 move on the first and the second guiding grooves 40, 41, respectively. The contours of the two moving parts 10, 11 contact the rod 20 at the contacting points 101 and 111, respectively, as shown in FIG. 2. The rod 20 includes a rotating point 23, a first and a second ends 21, 22. The rotating point 23 is set at a central portion 24 of the rod 20. The width Wc of the central portion 24 is narrower than the width W1 of the first end 21 and the width W2 of the second end 22. The distance D3 is set between the contacting point 101 and the first guiding groove 40 and the distance D4 is set between the contacting point 111 and the second guiding groove 41. The distance between the first and the second guiding grooves 40, 41 is H. Then the relationships among H, D3, D4, Wc, W1, and W2 are listed as the following equations: H<D3+W1+D4, H<D3+W2+D4 and H>D3+Wc+D4.

The operating processes of the logic apparatus of the present invention in FIG. 1 and FIG. 2 are the same. The operating process of the logic apparatus is described in the following paragraphs.

Please refer to FIG. 1 and FIGS. 3 to 5. The figures show the different state of the first embodiment during operating process.

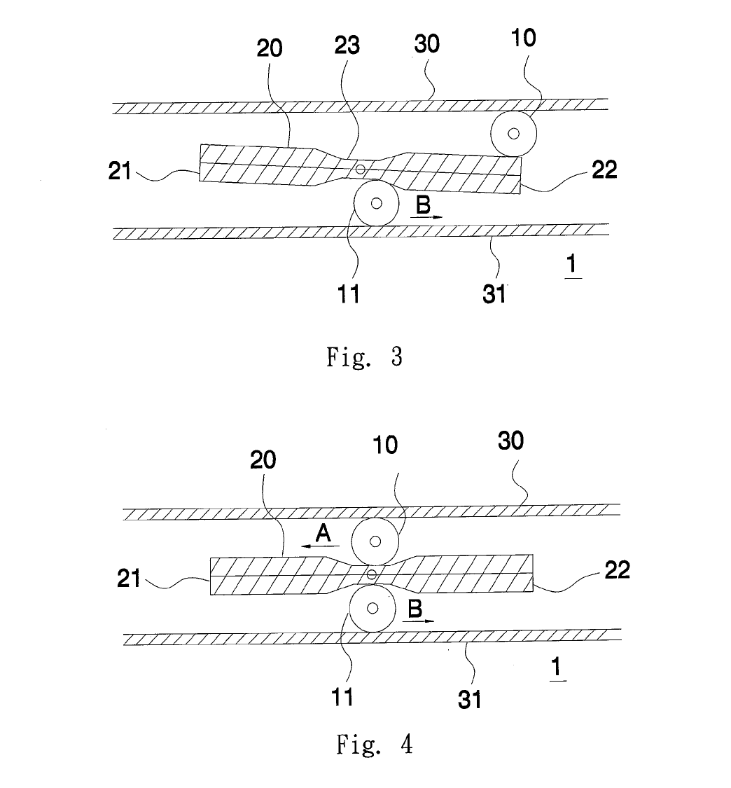

FIG. 1 shows the initial position of the logic apparatus 1. The first and the second moving parts 10, 11 are disposed at the different ends of the rod 20. When only the second moving part 11 moves in the direction of arrow B as shown in FIG. 1, the second moving part 11 can not move to the second end 22 because the distance D between the first and the second boundary is narrower than D1+W2+D2. Then the second moving part 11 is stopped at the central portion 24 as shown in FIG. 3. It is the same when only the first moving part 10 is moved in the direction of arrow A, the first moving part 10 is stopped at the central portion 24. It is the first state of the logic apparatus 1 when only one moving part is moved which is described above.

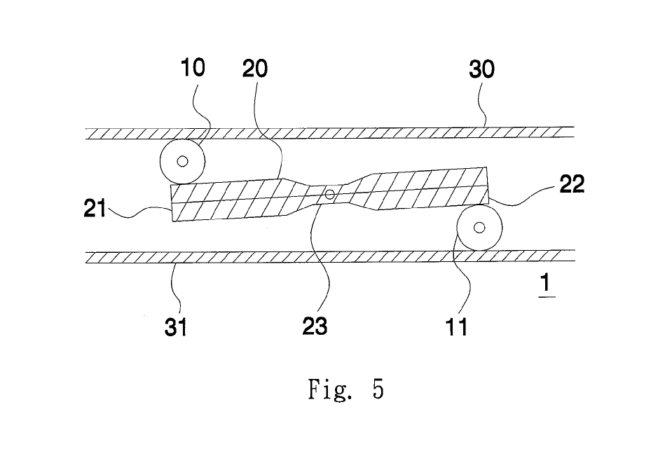

Please refer to FIG. 4. After the second moving part 11 is stopped at the central portion 24 and the first moving part 10 moves to the central portion 24. The two moving parts 10, 11 can be both positioned at the central portion 24 because the distance D between the first and the second boundaries 30, 31 is greater than D1+Wc+D2. When the first and the second moving parts 10, 11 move in the direction of arrow A and B, the first and the second moving parts 10, 11 can further move to the first end 21 and the second end 22 as shown in FIG. 5. It is the second state of the logic apparatus when the two moving parts move simultaneous or in turn. When the first and the second moving parts 10, 11 are at the first and the second ends 21, 22 as shown in FIG. 5, the first and the second moving parts 10, 11 can move to the second and the first ends 22, 21 which is the initial position of the logic apparatus 1. During the movement of the first and the second moving parts, the rod 20 is rotatable about the rotating point 23.

The operating process of the logic apparatus 1 is described above. For the initial position of the logic apparatus, two moving parts are at different ends, respectively. The first state of the logic apparatus is that only one moving part moves and the moved moving part cannot move to the other end of the rod. For the second state, the two moving parts move to the opposite end when both of the moving parts move simultaneous or in turn. According to the logic apparatus of the present invention, the operating process of the logic apparatus depends on the movement of the moving parts.

The logic apparatus can be widely applied to different devices. The logic apparatus can execute predetermined action by defining the movement of the moving parts. One of the applications will be described in the following paragraphs.

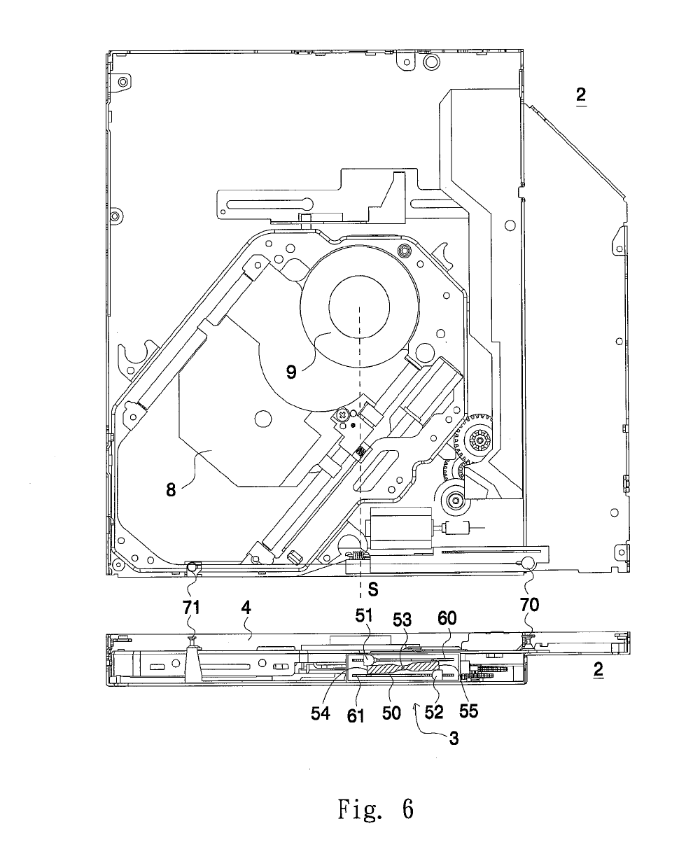

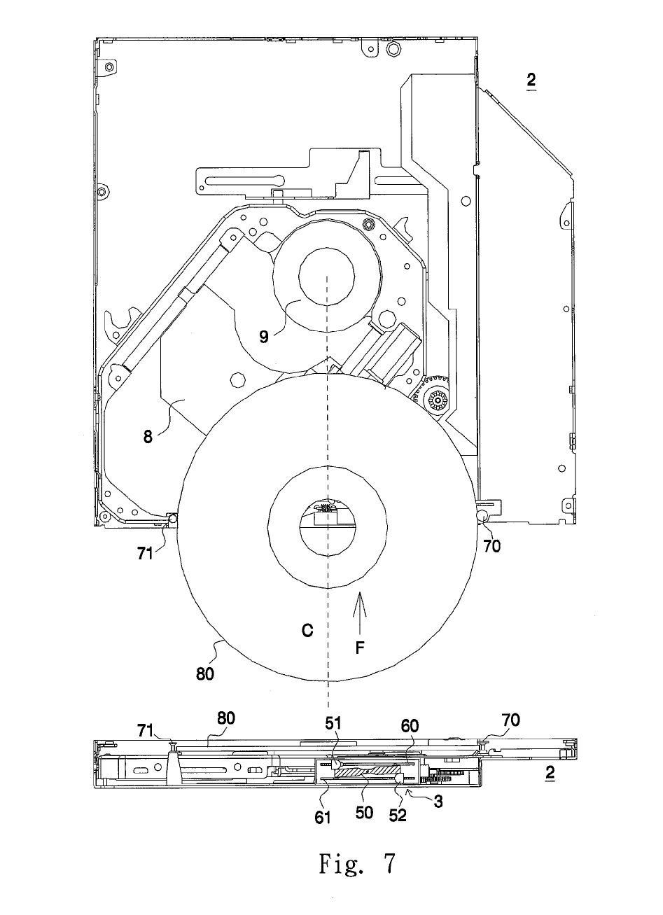

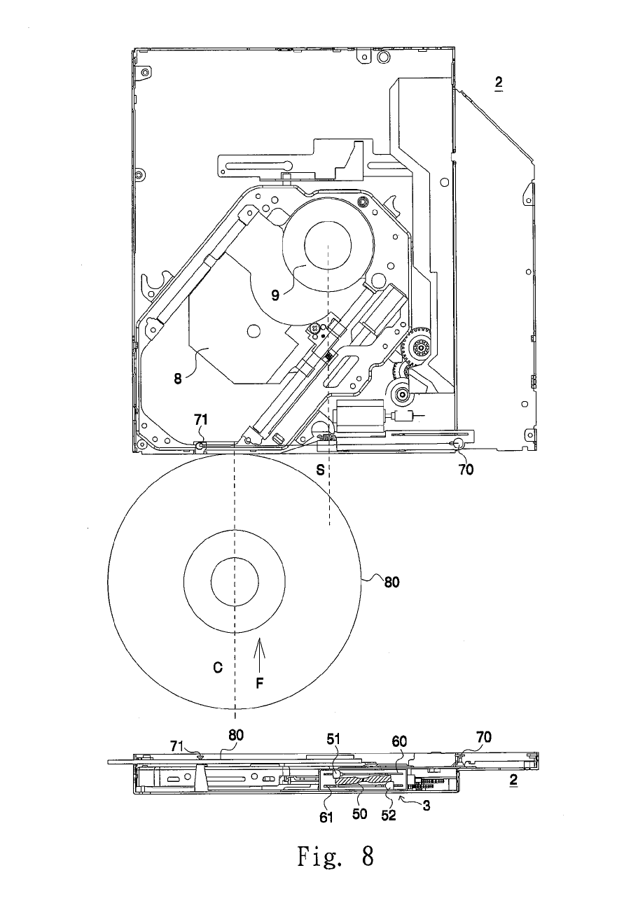

FIG. 6 shows a disc guiding apparatus of the present invention and FIGS. 7 to 11 show the disc guiding apparatus guiding the different sized discs to an appropriate position. After the disc is guided to the appropriate position, the disc is loaded into the optical disc drive by a disc loading apparatus.

Please refer to FIG. 6. The optical disc drive 2 includes an optical pickup head 8 for reading or writing information on an optical disc, a spindle motor 9 for supporting and rotating the optical disc, an insertion slot 4 for the disc to be inserted into the disc drive, a disc guiding apparatus 3, and a disc loading apparatus for loading the disc into the optical disc drive (not shown). The disc guiding apparatus 3 is installed at the insertion slot 4 and includes a logic apparatus and a first and a second disc guiding elements 70, 71. The logic apparatus includes a rod 50, a first and a second moving parts 51, 52 and a first and a second guiding grooves 60, 61. The elements and the operating process of the logic apparatus are the same as the logic apparatus 1 shown in FIG. 2 and they are omitted here.

The disc guiding elements 70, 71 are disposed symmetric to the center line S of the insertion slot 4. Each of the disc guiding elements 70, 71 has a concave part to support the outer edge of the optical disc. The first disc guiding element 70 is connected to the first moving part 51 and the second disc guiding element 71 is connected to the second moving part 52, respectively.

Please refer to FIG. 7. A 8 cm diameter disc 80, hereinafter the small disc 80, is pushed into the optical disc drive 2 at an appropriate position. In the embodiment, the appropriate position is defined as the center line C of the optical disc coincides with the center line S of the insertion slot 4. In the embodiment, the distance between the first and the second disc guiding elements 70, 71 are slightly greater than 8 cm. When the user pushes the small disc 80 into the optical disc drive 2 by force F, the disc would not contact the disc guiding elements 70, 71 at the appropriate position. When the small disc 80 is further pushed into the optical disc drive 2, the small disc 80 can be loaded to the reading position by the disc loading apparatus. The reading position is defined that the center of the disc is above the spindle motor 9 and can be clamped onto the spindle motor 9.

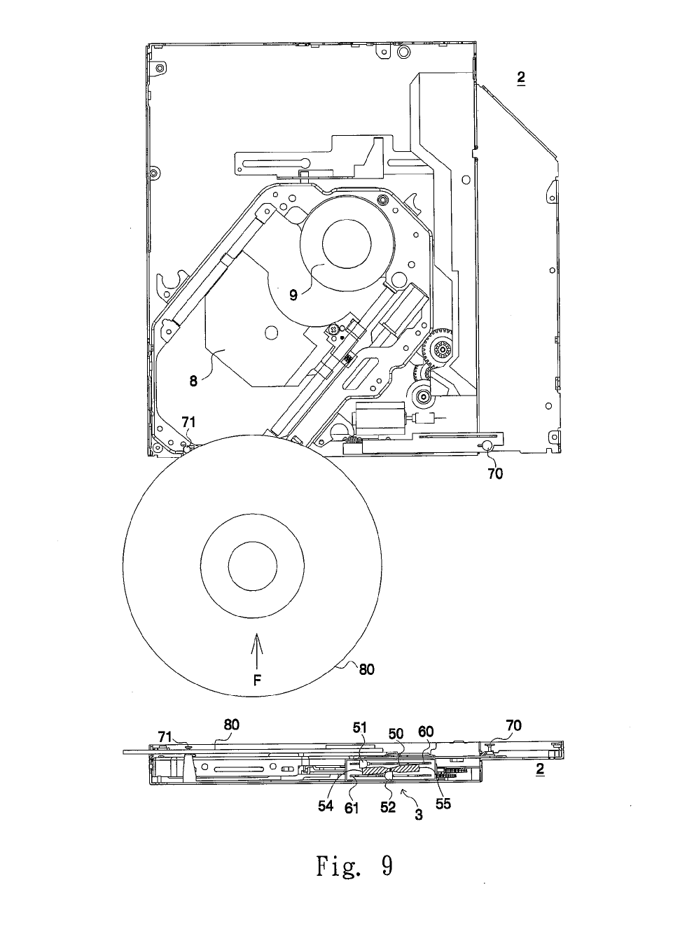

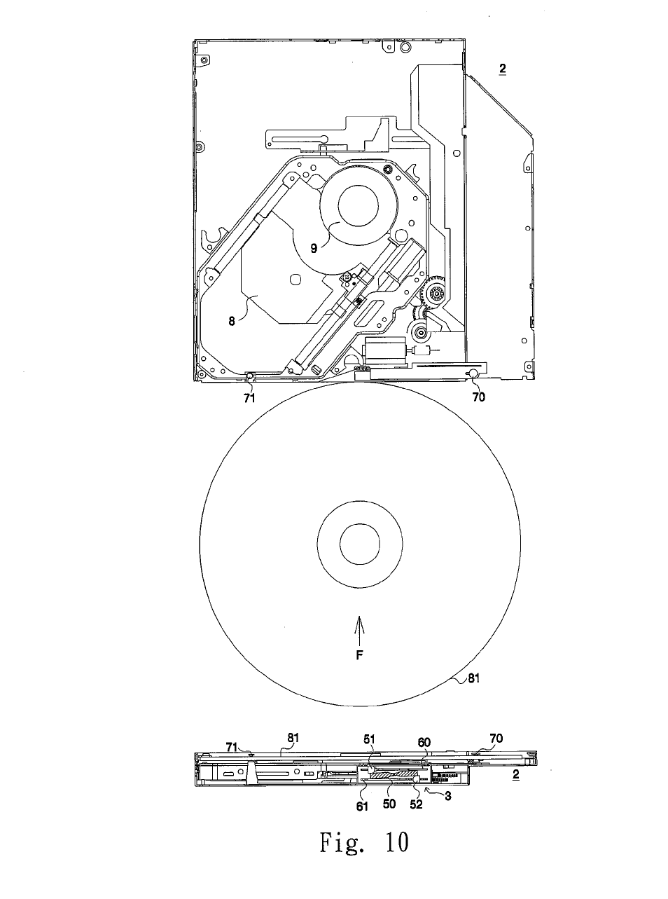

Referring to FIG. 8, the small disc 80 is pushed into the optical disc drive 2 at an inappropriate position. And FIG. 9 shows the disc guiding apparatus 3 guiding the small disc 80 into the optical disc drive 2. The inappropriate position is defined that the center line C of the small disc 80 does not coincide with the center line S of the insertion slot 4.

In FIG. 9, the contour of the small disc 80 only leans on the second disc guiding element 71. When the external force F pushes the small disc 80 into the optical disc drive 2, the outer edge of the small disc 80 pushes the second disc guiding element 71 to move leftward. At the same time, the second moving part 52 is moved. However, the second moving part 52 cannot move to the first end 54 because of the limitation described above. The second moving part 52 is positioned at the central portion of the rod 50. When the external force F further pushes the small disc 80 into the optical disc drive 2, the small disc 80 rotates about the second disc guiding element 71 and the center line C coincides with the center line S of the insertion slot 4. Therefore, the small disc 80 is positioned at the appropriate position and can be loaded to the reading position.

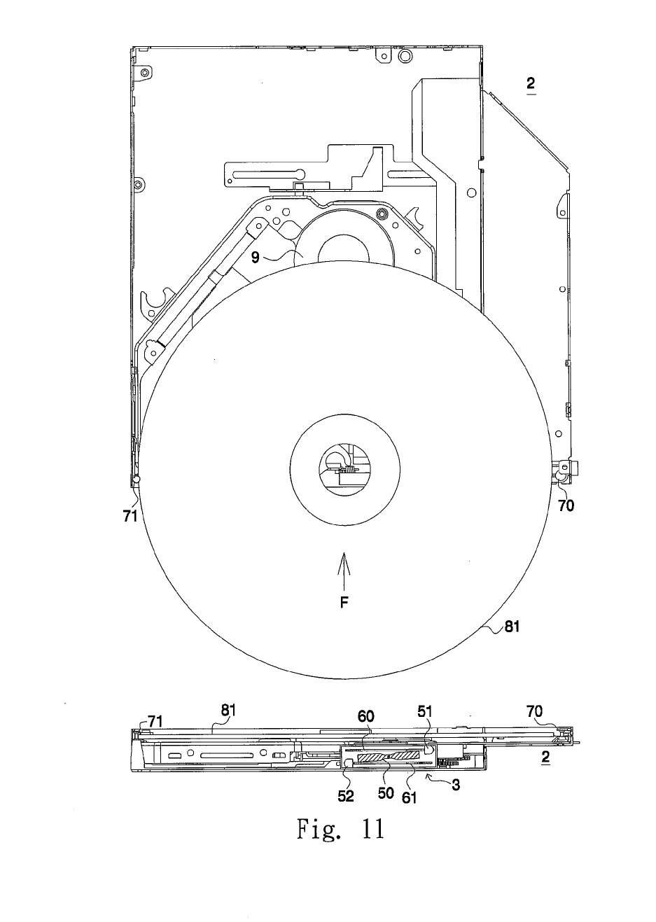

Referring to FIGS. 10 and 11, FIGS. 10 and 11 show the disc guiding apparatus 3 guiding the 12 cm diameter disc, hereinafter large disc, at an appropriate position. When the external force F pushes the large disc 81 into the optical disc drive 2, the outer edge of the large disc 81 is leant against the first and the second disc guiding elements 70, 71. The first and the second disc guiding elements 70, 71 are moved away from the center line S and the distance between the two disc guiding elements 70, 71 are increased.

For the logic apparatus, the first and the second moving parts 51, 52 are moved simultaneously or in turn to the central portion of the rod 50 because the first and the second disc guiding elements 70, 71 are moved. When the large disc 81 are further pushed into the optical disc drive 2, the first and the second moving parts 51, 52 are moved to the first and the second ends 54, 55 as shown in FIG. 11. The center line C of the large disc 81 coincides with the center line S, which means the large disc 81 is at the appropriate position. And then the large disc 81 can be loaded to the reading position by the disc loading apparatus.

The disc guiding apparatus including the logic apparatus of the present invention can judge different sized discs such as the small and the large discs by the movement of the moving parts. For example, a small disc is detected to be inserted into the disc when only one moving part is moved. And after the judgment, the loading/ejecting apparatus is modified to load the disc. The disc guiding apparatus also guides the disc to the appropriate position so that the discs can be loaded to the reading position as mentioned above. Therefore, the disc guiding apparatus of the present invention is able to guide and judge the different sized discs without additional apparatuses.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

I claim:

1. A disc guiding apparatus for an optical disc drive, wherein an optical disc is loaded into and ejected from the optical disc drive via passing through a disc insertion slot, wherein the disc guiding apparatus including:
a logic apparatus including:
a rod having a rotating point, a central portion and two ends, wherein the rotating point is at the central portion and the rod is rotatable about the rotating point, wherein the width of the central portion is narrower than that of each two ends;
two moving parts disposed at the two ends, respectively;
two guiding members guiding the two moving parts to be moved along the extended direction of the rod; and
two disc guiding elements disposed at the disc insertion slot and connected to the two moving part, respectively.

2. The disc guiding apparatus as claimed in claim 1, wherein the two guiding members are two boundaries disposed outside the two moving parts.

3. The disc guiding apparatus as claimed in claim 2, wherein the sum of the width of the central portion and the width of the two moving parts is less than the distance between the two boundaries; and the sum of the width of the two moving parts and either width of the two ends is greater than the distance between the two boundaries.

4. The disc guiding apparatus as claimed in claim 1, wherein the two guiding members are two guiding grooves and the two moving parts are moved on the two guiding grooves, wherein the two moving parts contact the ends of the rod.

5. The disc guiding apparatus as claimed in claim 4, wherein the sum of the width of the central portion and the distance between the guiding grooves and the rod is less than the distance between the two guiding grooves, and the sum of the either width of the two ends of the rod and the distance between the guiding grooves and the rod is greater than the distance between the two guiding grooves.

6. The disc guiding apparatus as claimed in claim 1, wherein the rod is an axial symmetric rod.

7. The disc guiding apparatus as claimed in claim 1, wherein each of the two disc guiding apparatus having a concave part for accepting the outer edge of the optical disc.

8. The disc guiding apparatus as claimed in claim 1, when only one moving part is moved, the moved moving part is stopped at the central portion of the rod.

9. The disc guiding apparatus as claimed in claim 1, when the two moving parts are moved simultaneously or in turn, the two moving parts move to the other ends opposite to an initial position.

10. A logic apparatus including:
a rod having a rotating point, a central portion and two ends, wherein the rotating point is at the central portion and the rod is rotatable about the rotating point, wherein the width of the central portion is narrower than each of the two ends;
two moving parts disposed at the two ends, respectively; and
two guiding members guiding the two moving parts to be moved along the extended direction of the rod.

11. The logic apparatus as claimed in claim 10, wherein the two guiding members are two boundaries disposed outside the two moving parts.

12. The logic apparatus as claimed in claim 11, wherein the sum of the width of the central portion and the widths of the two moving parts are less than the distance between the two boundaries; and the sum of the widths of the two moving parts and either width of the two ends are greater than the distance between the two boundaries.

13. The logic apparatus as claimed in claim 10, wherein the two guiding members are two guiding grooves and the two moving parts are moved on the two guiding grooves, wherein the contour of the two moving parts contacting the rod.

14. The disc guiding apparatus as claimed in claim 13, wherein the sum of the width of the central portion and the distance between the guiding grooves and the rod is less than the distance between the two guiding grooves, and the sum of the either width of the two ends of the rod and the distance between the guiding grooves and the rod is greater than the distance between the two guiding grooves.

15. The logic apparatus as claimed in claim 10, wherein the rod is an axial symmetric rod.
